(19) United States
(12) Patent Application Publication
(10) Pub. No.: US 2005/0094012 A1
(43) Pub. Date: May 5, 2005

(54) Solid-state image sensing apparatus

(76) Inventors: Yuichi Gomi, Hachioji-shi (JP); Seisuke Matsuda, Hachioji-shi (JP); Yukihiro Kuroda, Hachioji-shi (JP); Keiichi Mori, Hachioji-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 10/930,706

(22) Filed: Aug. 31, 2004

(30) Foreign Application Priority Data
Sep. 4, 2003 (JP) 2003-312720
Sep. 4, 2003 (JP) 2003-312721

(51) Int. Cl. H04N 5/335

(52) U.S. Cl. 348/308

(57) ABSTRACT

In a solid-state image sensing apparatus according to one mode of the present invention, a vertical scanning circuit and a horizontal scanning circuit are controlled to thereby alternately read a middle portion continuous signal and a whole region decimation signal of pixels for each frame in accordance with a use application. Moreover, a pixel row selected in reading the middle portion continuous signal is common to that selected in reading the whole region decimation signal, and further as to each selected pixel row, a pixel signal of a middle portion is read as the middle portion continuous signal, and a pixel signal obtained by decimation every predetermined pixels is read as the whole region decimation signal.

### CROSS-REFERENCE TO RELATED APPLICATIONS

This application is based upon and claims the benefit of priority from prior Japanese Patent Applications No. 2003-312720, filed Sep. 4, 2003; and No. 2003-312721, filed Sep. 4, 2003, the entire contents of both of which are incorporated herein by reference.

### BACKGROUND OF THE INVENTION

1. Field of the Invention

The present invention relates to a solid-state image sensing apparatus applied, for example, to an electronic camera or the like, particularly to a solid-state image sensing apparatus capable of alternately reading a plurality of types of signals for each frame in accordance with a use application.

2. Description of the Related Art

In recent years, in digital still cameras, the number of pixels has increased, and mounted image sensing devices have several millions of pixels in many cases. With the increase in the number of the pixels, a time for reading one frame of signals lengthens. When dynamic image recording or dynamic image sensing for view finder display is to be performed with the use of this high-pixel image sensing device, the number of frames per unit time (second) is small, and a quality of the dynamic image is very low. To improve this, a signal reading operation from the image sensing device is performed in a reduced manner, accordingly the number of the pixels per frame is reduced, the number of the frames per second is increased, and the quality of the dynamic image has been enhanced in this manner. Moreover, as an AF method at a dynamic image sensing time, a mountain climbing system using the image sensing device has been generally used. In the system, focusing is judged utilizing high-frequency components of image sensing signals. Therefore, when the image sensing signals are reduced, and the dynamic image sensing is performed, a problem has occurred that AF precision drops.

As a technique for enhancing the precision of the AF, an X-Y address type solid-state image sensing apparatus has been described, for example, in Jpn. Pat. Appln. KOKAI Publication No. 2000-156823. In this solid-state image sensing apparatus, some of two-dimensionally arranged pixel portions are constituted to output signals for the AF, and the signals suitable for the AF are obtained to thereby enhance the precision. In this solid-state image sensing apparatus, photoelectric conversion cells for converting optical images formed by an optical system into electric signals are two-dimensionally arranged. Some cells in this photoelectric conversion cell group output signals other than those for forming image signals, that is, signals for ranging.

### BRIEF SUMMARY OF THE INVENTION

An object of one mode of the present invention is to realize high-speed reading at an enhanced frame rate and reduction of power consumption while maintaining a simple constitution, further to alternately read a plurality of types of signals in accordance with use applications.

To achieve the object, according to one mode of the present invention, there is provided a solid-state image sensing apparatus having: a photoelectric conversion unit constituted of a plurality of two-dimensionally arranged pixels; a vertical scanning circuit which selects a pixel row constituting a reading object of the photoelectric conversion unit; a transfer switch which is connected to an output signal line of each of the pixels and which is driven/controlled by a transfer signal; a line memory which stores a pixel signal transferred from the pixel via the transfer switch; a horizontal scanning circuit which outputs a horizontal selection signal; a horizontal selection switch which is driven/controlled by the horizontal selection signal; and an output channel which reads the pixel signal from the line memory via the horizontal selection switch, wherein reading of a middle portion continuous signal of the pixel and reading of a whole region decimation signal of the pixel are alternately performed for each frame in accordance with a use application by control of the vertical scanning circuit and the horizontal scanning circuit.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a constitution diagram of a solid-state image sensing apparatus common to first to fourth embodiments of the present invention;

FIG. 2 is a diagram showing a constitution example of pixels P11 to Pmn of FIG. 1;

FIG. 3 is a timing chart of each signal concerning a constitution of FIG. 1;

FIG. 4 is a timing chart concerning successive reading of all the pixels P11 to Pmn of the solid-state image sensing apparatus according to the first to fourth embodiments of the present invention;

FIG. 5 is a diagram showing a reading pattern example of a whole region decimation signal by the solid-state image sensing apparatus according to the first embodiment of the present invention;

FIG. 6 is a diagram showing a reading pattern example of a middle portion continuous signal by the solid-state image sensing apparatus according to the first embodiment of the present invention;

FIG. 7 is a timing chart showing a characteristic reading operation by the solid-state image sensing apparatus according to the first embodiment of the present invention in further detail;

FIG. 8 is a diagram showing a reading pattern example of the middle portion continuous signal by the solid-state image sensing apparatus according to a second embodiment of the present invention;

FIG. 9 is a timing chart showing the characteristic reading operation by the solid-state image sensing apparatus according to the second embodiment of the present invention in further detail;

FIG. 10 is a diagram showing a reading pattern example of the middle portion continuous signal by the solid-state image sensing apparatus according to a third embodiment of the present invention;

FIG. 11 is a timing chart showing the characteristic reading operation by the solid-state image sensing apparatus according to the third embodiment of the present invention in further detail;

FIG. 12 is a diagram showing a reading pattern example of the middle portion continuous signal by the solid-state image sensing apparatus according to a fourth embodiment of the present invention;

FIG. 13 is a timing chart showing the characteristic reading operation by the solid-state image sensing apparatus according to the fourth embodiment of the present invention in further detail;

FIG. 14 is a diagram showing a constitution example of a shift register applicable as a scanning circuit which performs successive scanning and decimation scanning in the solid-state image sensing apparatus according to first to fourth embodiments of the present invention;

FIG. 15 is a conceptual diagram showing the successive scanning by the constitution of FIG. 14;

FIG. 16 is a conceptual diagram showing the decimation scanning by the constitution of FIG. 14;

FIG. 17 is a constitution diagram of the solid-state image sensing apparatus common to fifth to eighth embodiments of the present invention;

FIG. 18 is a timing chart concerning the successive reading of all the pixels P11 to Pmn of the solid-state image sensing apparatus according to the fifth to eighth embodiments of the present invention;

FIG. 19 is a timing chart showing the characteristic reading operation by the solid-state image sensing apparatus according to the fifth embodiment of the present invention in further detail;

FIG. 20 is a timing chart showing the characteristic reading operation by the solid-state image sensing apparatus according to the sixth embodiment of the present invention in further detail;

FIG. 21 is a diagram showing a constitution example of a vertical scanning circuit 30 adopted by the solid-state image sensing apparatus according to the seventh, eighth embodiments of the present invention;

FIG. 22 is a timing chart showing the characteristic reading operation by the solid-state image sensing apparatus according to the seventh embodiment of the present invention in further detail; and

FIG. 23 is a timing chart showing the characteristic reading operation by the solid-state image sensing apparatus according to the eighth embodiment of the present invention in further detail.

### DETAILED DESCRIPTION OF THE INVENTION

Embodiments of the present invention will be described hereinafter with reference to the drawings.

A solid-state image sensing apparatus according to the embodiments of the present invention alternately reads a plurality of types of signals in accordance with use applications. For example, when the apparatus is applied to an electronic camera or the like, decimation reading of all pixels for image display in a finder mode, and continuous reading of a pixel middle portion for a calculation process such as AF are alternately performed for each frame.

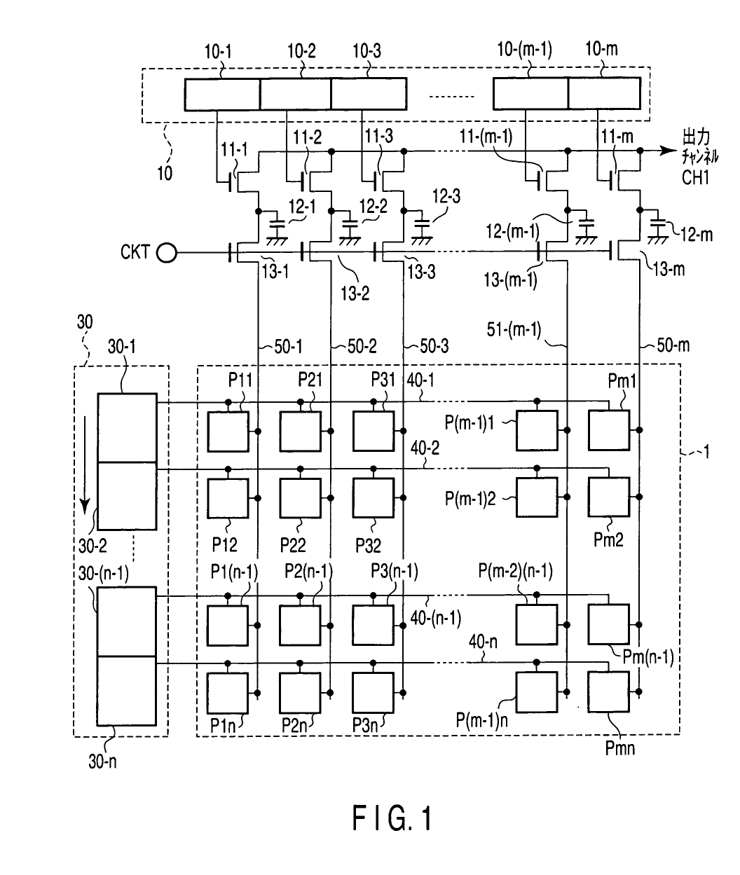

First, a constitution of the solid-state image sensing apparatus common to first to fourth embodiments of the present invention is shown in FIG. 1, and will be described in detail.

In FIG. 1, symbols P11 to Pmn (m, n are natural numbers) show m×n pixels two-dimensionally arranged in a matrix. A solid-state image sensing apparatus (photoelectric conversion unit) 1 comprises the plurality of pixels P11 to Pmn. A vertical scanning circuit 30 successively scans lines 40-1 to 40-n, and comprises a plurality of units 30-1 to 30-n corresponding to the respective lines 40-1 to 40-n.

A horizontal scanning circuit 10 successively reads electric signals derived to output signal lines 50-1 to 50-m from the respective pixels P11 to Pmn for each pixel in a horizontal direction. The horizontal scanning circuit 10 comprises a plurality of units 10-1 to 10-m corresponding to the respective output signal lines 50-1 to 50-m. It is to be noted that the respective pixels P11 to Pmn are also connected to lines other than the lines 40-1 to 40-n and the output signal lines 50-1 to 50-m, but the lines are omitted from the drawing here.

Moreover, on one end of each of the output signal lines 50-1 to 50-m on the side of the horizontal scanning circuit 10, a set of each of transistors 13-1 to 13-m, line memories 12-1 to 12-m, and transistors 11-1 to 11-m is disposed as shown.

The transistors 13-1 to 13-m have functions of transfer switches for transferring signals of a pixel row selected by the vertical scanning circuit 30 to the line memories 12-1 to 12-m, and are constituted to be controlled to be on/off by a clock CKT for control (the transistors 13-1 to 13-m will be hereinafter referred to as the “transfer switches”).

Furthermore, the line memories 12-1 to 12-m comprise capacity devices for temporarily storing pixel signals transferred from the pixels P11 to Pmn via the transfer switches 13-1 to 13-m. The transistors 11-1 to 11-m have functions of horizontal selection switches for selecting the pixel signals stored in the line memories 12-1 to 12-m.

The transistors 11-1 to 11-m are constituted to be controlled to be on/off by an output signal of the horizontal scanning circuit 10 (the transistors 11-1 to 11-m will be hereinafter referred to as the “horizontal selection switches”). Additionally, an output channel CH1 for reading the pixel signal via the horizontal selection switches 11-1 to 11-m is disposed.

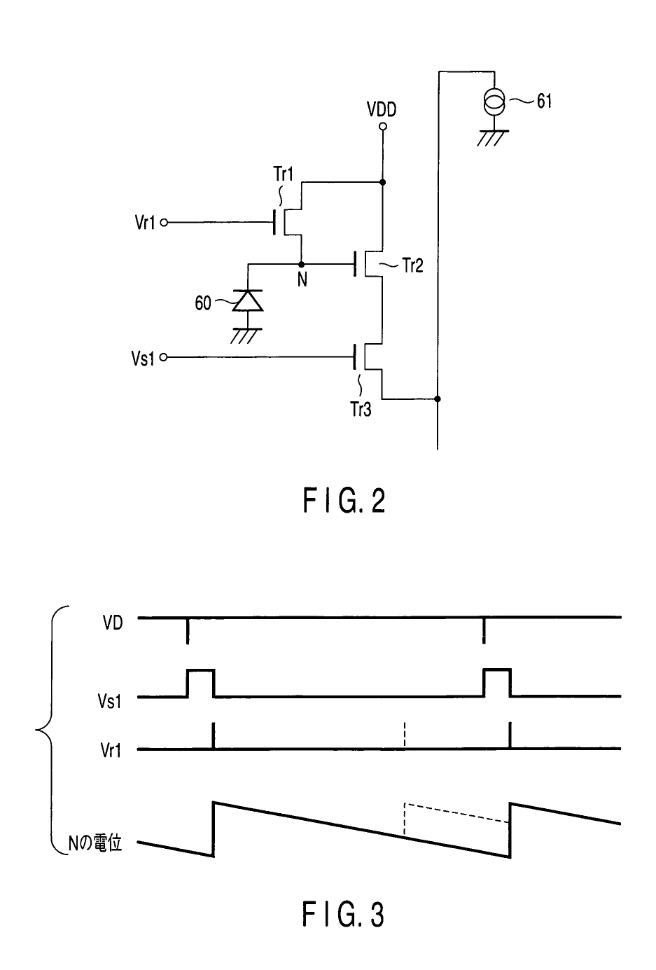

Here, FIG. 2 shows a constitution example of the respective pixels P11 to Pmn, FIG. 3 shows a timing chart relating to a state of each signal, and the constitution and function will be described in further detail.

First, as shown in FIG. 2, to constitute each of the pixels P11 to Pmn, a photo diode (hereinafter referred to as PD) 60, a transistor Tr1 for resetting the PD 60, a transistor Tr2 for amplifying a signal of the PD 60, and a transistor Tr3 for reading the amplified signal to a vertical signal line are connected to one another as shown. A current source 61 is disposed in each column of the respective pixels P11 to Pmn, and the current source 61 and the transistor Tr2 constitute a follower amplifier. Additionally, VDD is a power supply. It is to be noted that, needless to say, other various types may be adopted as the pixels P11 to Pmn.

In this constitution, as shown in the timing chart of FIG. 3, when a pixel selection signal Vs1 has an “H” level in synchronization with falling of a vertical synchronous signal VD, the transistor Tr3 for the selection is turned on. Subsequently, when a pixel reset signal Vr1 has an “H” level in synchronization with the falling of the pixel selection signal Vs1, the transistor Tr1 for resetting is turned on, and a charge of the PD 60 is reset. That is, a potential of a node N is that of the PD 60, but at the time of the resetting, the PD 60 is reset at a power supply level. Thereafter, when light enters the PD 60, electricity is discharged by a generated charge, and the level gradually lowers. Moreover, when the pixel selection signal Vs1 turns to the “H” level in the next frame, the potential of the PD 60 is read out to the vertical signal line. It is to be noted that the pixel reset signal Vr1 is set to the “H” level before the pixel selection signal Vs1 turns to “H” in the next frame, then the charge is reset, and an accumulation operation, that is, a shutter operation is performed at this timing.

Moreover, in the first to fourth embodiments of the present invention, all the pixels P11 to Pmn can be successively read by the above-described constitution and function, and may be decimated and read. That is, two types of signals can be alternately read for each frame in accordance with the use application.

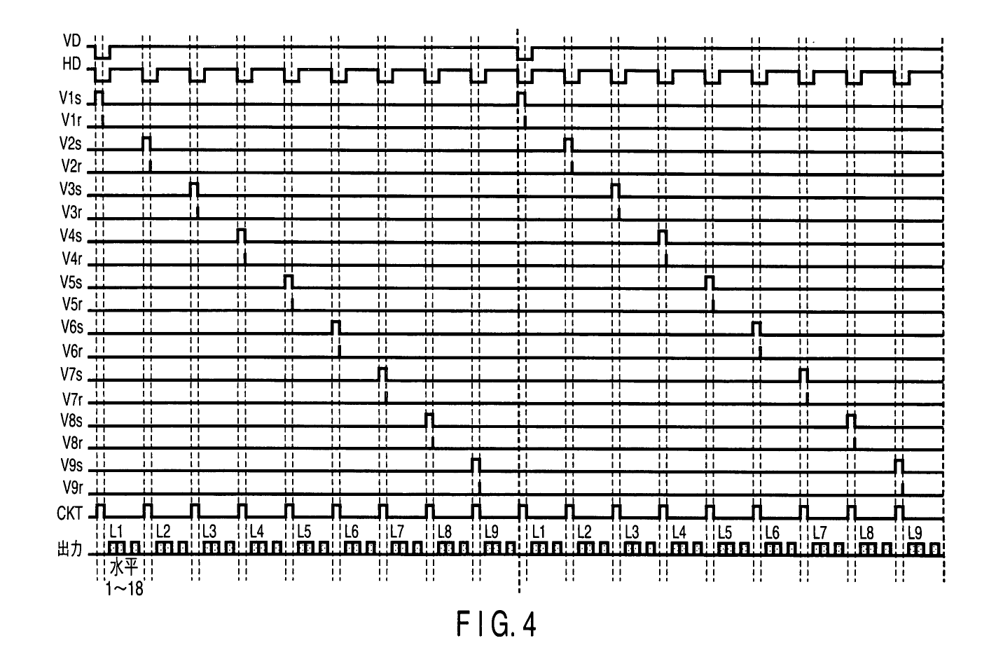

Successive reading of all the pixels P11 to Pmn of the solid-state image sensing apparatus according to the first to fourth embodiments constituted as described above will be described hereinafter with reference to a timing chart of FIG. 4.

VD denotes a vertical synchronous signal, HD denotes a horizontal synchronous signal, V1s, V2s, . . . denote pixel selection signals, V1r, V2r, . . . denote pixel reset signals, CKT is a clock input into the transfer switch, and an output is a pixel signal output from an output channel.

In this successive reading operation, the vertical scanning circuit 30 successively performs the scanning in an arrangement direction of the respective units 30-1, 30-2, . . . 30-n. That is, when a pixel selection signal V1s output from the vertical scanning circuit 30 turns to the “H” level in a horizontal blanking period (period in which the horizontal selection signal HD has an “L” level), the pixels P11 to Pmn of a first row are selected. In this case, since the clock CKT input into the transfer switches 13-1 to 13-m has the “H” level, the pixel signals of the selected pixels P11 to Pm1 are stored in the line memories 12-1 to 12-m. Thereafter, a pixel reset signal V1r turns to the “H” level, and the charges of the pixels P11 to Pm1 are reset. Thereafter, the horizontal scanning circuit 10 is successively scanned in a horizontal valid period (period in which the horizontal synchronous signal HD has the “H” level). That is, when the units 10-1 to 10-m of the horizontal scanning circuit 10 are scanned, the respective units output the horizontal selection signals in order.

Accordingly, the pixel signals of pixels P11 to Pm1 of the first row are output from the output channel CH1 via the horizontal selection switches 11-1 to 11-m.

When a pixel selection signal V2s output from the vertical scanning circuit 30 turns to the “H” level in the next horizontal blanking period (period in which the horizontal synchronous signal HD has the “L” level), pixels P12 to Pm2 of a second row are selected. In this period, since the clock CKT input into the transfer switches 13-1 to 13-m has the “H” level, the pixel signals of the selected pixels P12 to Pm2 are stored in the line memories 12-1 to 12-m. Thereafter, the a pixel reset signal V2r turns to the “H” level, and the charges of the pixels P12 to Pm2 are reset.

Thereafter, the horizontal scanning circuit 10 is successively scanned in the horizontal valid period (period in which the horizontal synchronous signal HD has the “H” level). That is, when the horizontal scanning circuit 10 is scanned toward the respective units 10-1 to 10-m, each unit is made to output the horizontal selection signal in order.

Accordingly, the pixel signals of the pixels P12 to Pm2 of the second row are output from the output channel CH1 via the horizontal selection switches 11-1 to 11-m.

Thereafter, the pixels of each row are similarly successively selected in the horizontal blanking period, the pixel signal is output from each row in the horizontal valid period, and accordingly all the pixels are successively read.

Characteristic operations of the first to fourth embodiments will be described hereinafter in detail on the assumption of the above-described constitution and function of the solid-state image sensing apparatus.

### FIRST EMBODIMENT

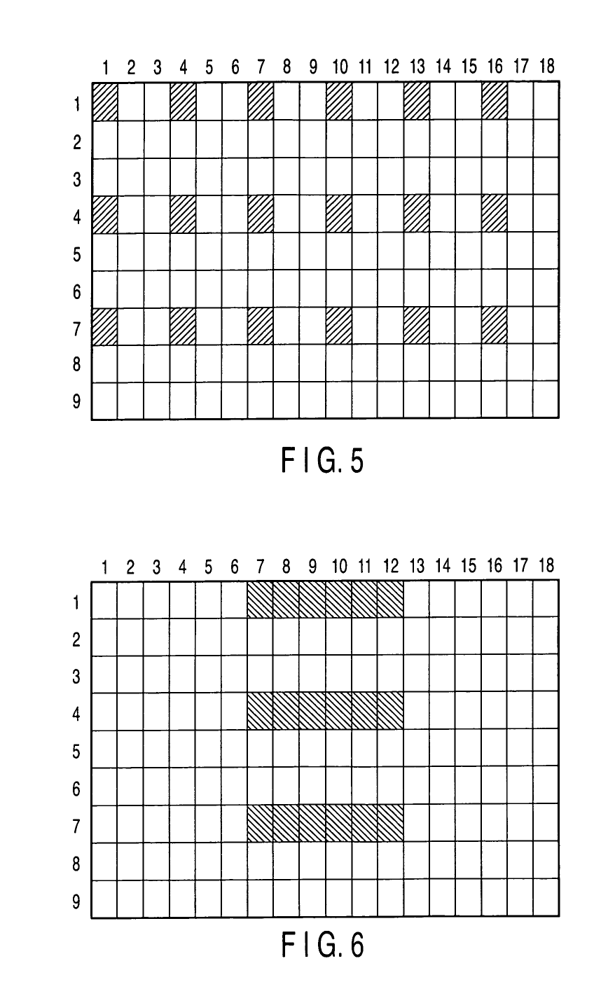

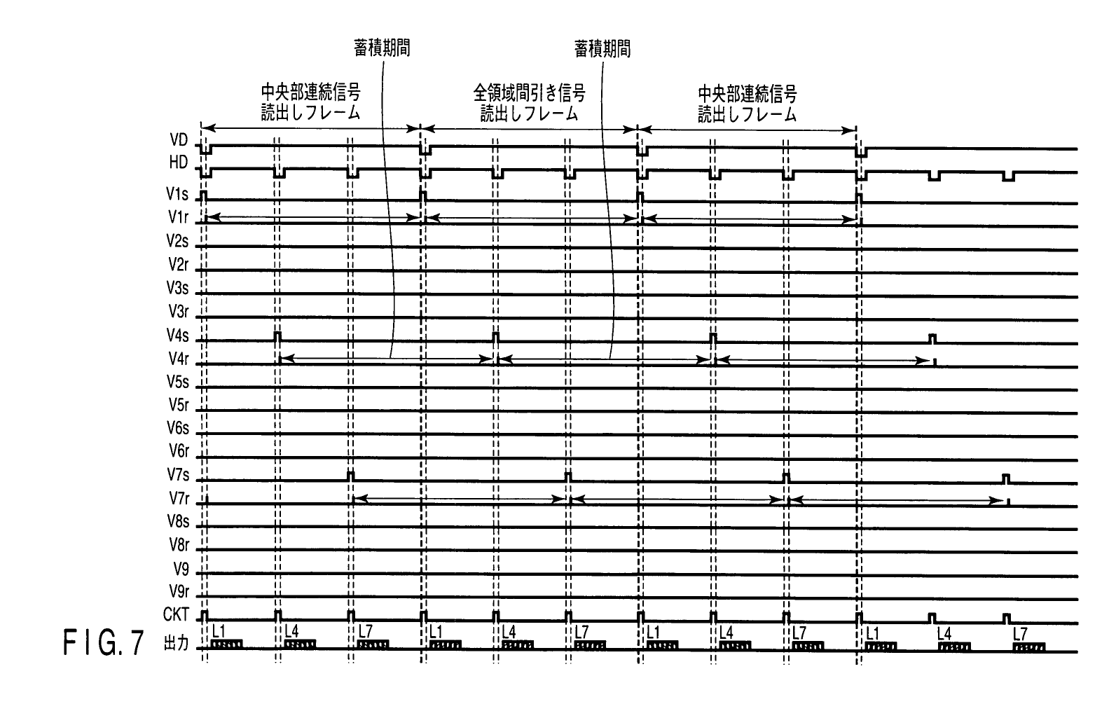

A solid-state image sensing apparatus according to a first embodiment of the present invention will be described hereinafter in detail with reference to FIGS. 5 to 7. It is to be noted that FIG. 5 shows a reading pattern example of a whole region decimation signal, FIG. 6 shows a reading pattern example of a middle portion continuous signal, and FIG. 7 is a timing chart showing timings for alternately reading these signals for each frame.

As shown in FIGS. 5, 6, in the solid-state image sensing apparatus according to the first embodiment, the middle portion continuous signal is read in a first frame, the whole region decimation signal is read in a second frame, and subsequently this is alternately repeated for each frame. In this case, the row selected in reading the middle portion continuous signal and the row selected in reading the whole region decimation signal are common (first, fourth, seventh rows are selected in order in this example). Furthermore, in each row, signals only of the pixels (seventh to twelfth columns in this example) of a middle portion are read as the middle portion continuous signals, signals of pixels from which two pixels are decimated (first, fourth, seventh, tenth, 13-th, 16-th columns) are read as the whole region decimation signals. Different respects here are that a vertical scanning circuit 30 selects the same row in the frame of the whole region decimation signal and that of the middle portion continuous signal, but a method of selection in a horizontal scanning circuit 10 is changed.

A characteristic reading operation by the solid-state image sensing apparatus according to the first embodiment will be described hereinafter in further detail with reference to the timing chart of FIG. 7.

VD denotes a vertical synchronous signal, HD denotes a horizontal synchronous signal, V1s, V2s, . . . denote pixel selection signals, V1r, V2r, . . . denote pixel reset signals, CKT is a clock input into the transfer switch, and an output is a pixel signal output from an output channel.

The middle portion continuous signal is read in the first frame as shown in FIG. 6.

The vertical scanning circuit 30 first scans the first row along an arrangement direction of units 30-1, 30-2, . . . , 30-n. That is, when the pixel selection signal V1s output from the vertical scanning circuit 30 turns to an “H” level in a horizontal blanking period (period in which a horizontal synchronous signal HD has an “L” level), pixels P11 to Pm1 of a first row are selected. In this period, since the clock CKT input into transfer switches 13-1 to 13-m has the “H” level, pixel signals of the selected pixels P11 to Pm1 are stored in line memories 12-1 to 12-m. Thereafter, the pixel reset signal V1r turns to the “H” level, and charges of the pixels P11 to Pm1 are reset.

Thereafter, units 10-7 to 10-12 of the horizontal scanning circuit 10 output horizontal selection signals in a horizontal valid period (period in which the horizontal synchronous signal HD has the “H” level), and the pixel signals of the pixels in the selected seventh to 12-th columns in the pixels P11 to Pm1 of the first row are output from an output channel CH1 via horizontal selection switches 11-7 to 11-12.

Thereafter, the pixels (the respective seventh to twelfth columns) of the fourth and seventh rows are similarly successively selected in the horizontal blanking period, pixel signals of the selected columns (the respective seventh to twelfth columns) for each row are output in the horizontal valid period, and accordingly reading is performed as shown in FIG. 6.

In the second frame, the whole region decimation signal is read as shown in FIG. 5.

The vertical scanning circuit 30 first scans the first row along an arrangement direction of the respective units 30-1, 30-2, . . . , 30-n. That is, when the pixel selection signal V1s output from the vertical scanning circuit 30 turns to the “H” level in the horizontal blanking period (period in which the horizontal synchronous signal HD has the “L” level), the pixels P11 to Pm1 of the first row are selected. In this period, since the clock CKT input into the transfer switches 13-1 to 13-m has the “H” level, the pixel signals of the selected pixels P11 to Pm1 are stored in the line memories 12-1 to 12-m. Thereafter, the pixel reset signal V1r turns to the “H” level, and the charges of the pixels P11 to Pm1 are reset.

Thereafter, units 10-1, 10-4, 10-7, 10-10, 10-13, 10-16 of the horizontal scanning circuit 10 output horizontal selection signals in the horizontal valid period (period in which the horizontal synchronous signal HD has the “H” level), and the pixel signals of the pixels in selected first, fourth, seventh, tenth, 13-th, 16-th columns in the pixels P11 to Pm1 of the first row are output from the output channel CH1 via horizontal selection switches 11-1, 11-4, 11-7, 11-10, 11-13, 11-16. Thereafter, fourth, seventh rows of the pixels (the respective first, fourth, seventh, tenth, 13-th, 16-th columns) are successively selected in the horizontal blanking period in the same manner as described above, the pixel signals of the selected columns (the respective first, fourth, seventh, tenth, 13-th, 16-th columns) for each row are output in the horizontal valid period, and accordingly the reading shown in FIG. 5 is performed.

Moreover, the reading of the middle portion continuous signal, and the reading of the whole region decimation signal are alternately repeated for each frame.

According to the first embodiment described above, in the case of the high pixels, when all the pixel signals are output simultaneously, a problem occurs in a frame rate. However, since the reading of the whole region decimation signal (e.g., for display), and the reading of the middle portion continuous signal (e.g., for AF) are alternately repeated for each frame, outputs are easily obtained in accordance with a use application.

### SECOND EMBODIMENT

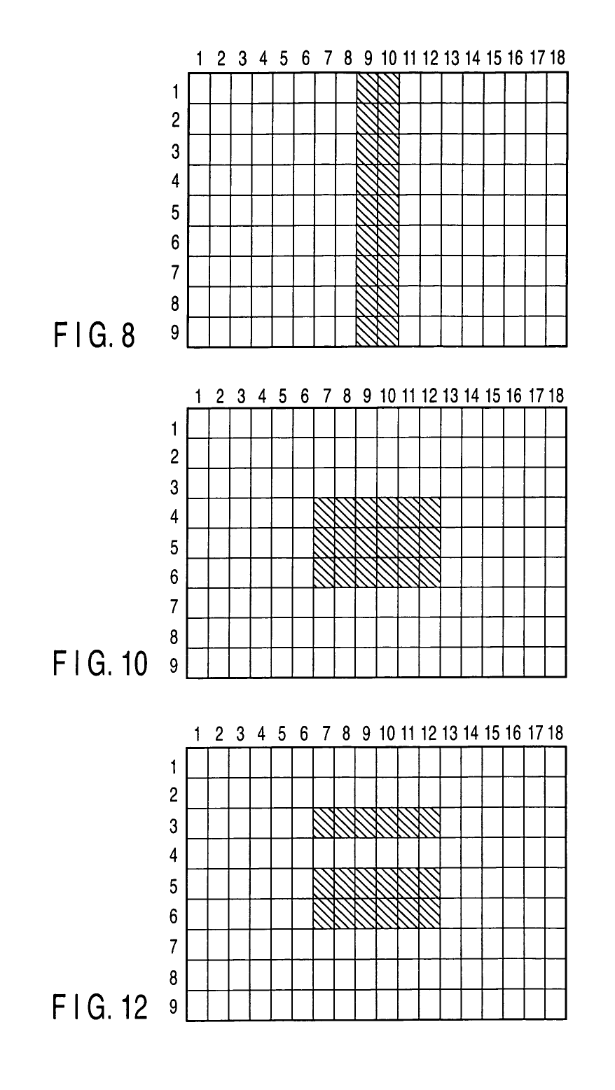

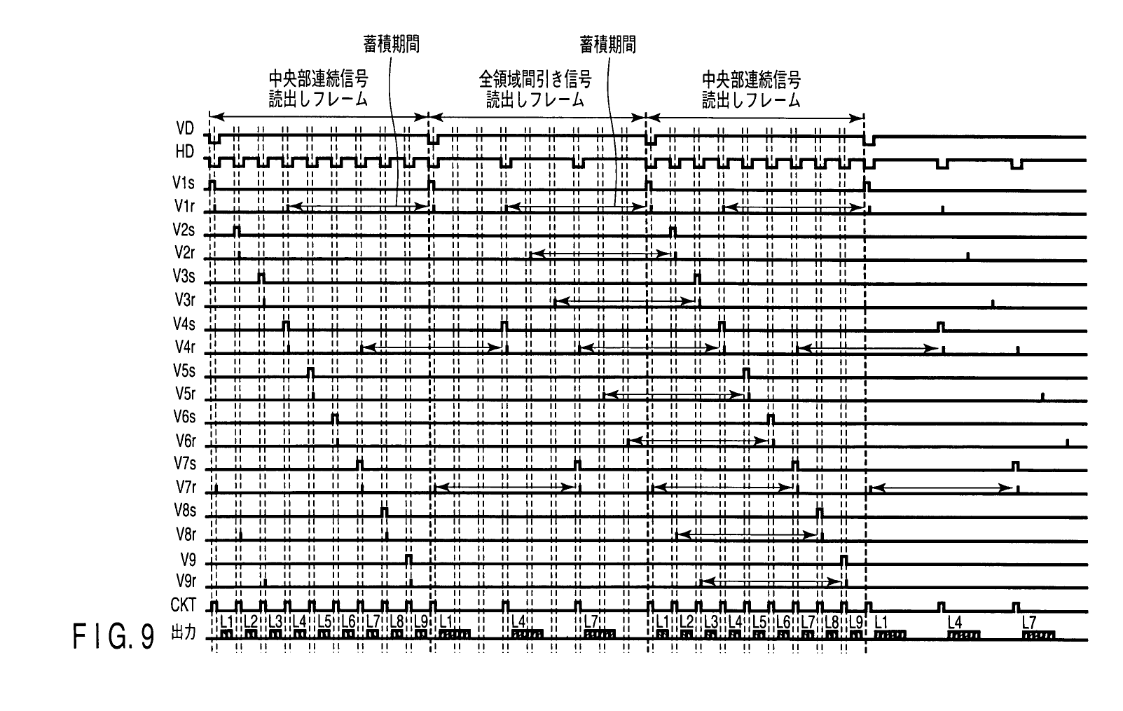

A solid-state image sensing apparatus according to a second embodiment of the present invention will be described hereinafter in detail with reference to FIGS. 8 and 9. It is to be noted that FIG. 8 shows a reading pattern example of the middle portion continuous signal, and FIG. 9 is a timing chart showing timings for alternately reading pixels for each frame in a mode shown in FIGS. 5, 8 in detail. FIG. 5 is hereinafter appropriately referred to.

In the solid-state image sensing apparatus according to the second embodiment, a middle portion continuous signal is read in a first frame as shown in FIG. 8, a whole region decimation signal is read in a second frame, and subsequently this is alternately repeated for each frame. In this case, only a middle portion (ninth, tenth columns) is read without decimation in a vertical direction in the reading of the middle portion continuous signal. Furthermore, since rows to read differ with frames, a pixel reset signal V1r is set to an “H” level at a predetermined timing (using an electronic shutter), and pixels are reset in order to obtain uniform accumulation times. For example, in reading the whole region decimation signal, signals of a second row are not read, but the accumulation time is controlled using the electronic shutter, and the accumulation time in the subsequent reading of the middle portion continuous signal is controlled. Here, a cycle of a horizontal synchronous signal HD in reading the whole region decimation signal is integer times that of the horizontal synchronous signal HD in reading the middle portion continuous signal. Therefore, pixels are reset while shifting a phase in consideration of continuous reading with respect to decimation-read rows in accordance with the number of decimated pixels.

A characteristic reading operation by the solid-state image sensing apparatus according to the second embodiment will be described hereinafter in further detail with reference to the timing chart of FIG. 9.

VD denotes a vertical synchronous signal, HD denotes a horizontal synchronous signal, V1s, V2s, . . . denote pixel selection signals, V1r, V2r, . . . denote pixel reset signals, CKT is a clock input into a transfer switch, and an output is a pixel signal output from an output channel.

The middle portion continuous signal is read in the first frame as shown in FIG. 8.

A vertical scanning circuit 30 first scans the first row along an arrangement direction of units 30-1, 30-2, , 30-n. That is, when the pixel selection signal V1s output from the vertical scanning circuit 30 turns to an “H” level in a horizontal blanking period (period in which a horizontal synchronous signal HD has an “L” level), pixels P11 to Pm1 of a first row are selected. In this period, since the clock CKT input into transfer switches 13-1 to 13-m has the “H” level, pixel signals of the selected pixels P11 to Pm1 are stored in line memories 12-1 to 12-m. Thereafter, the pixel reset signal V1r turns to the “H” level, and charges of the pixels P11 to Pm1 are reset.

Thereafter, units 10-9, 10-10 of a horizontal scanning circuit 10 output horizontal selection signals in a horizontal valid period (period in which the horizontal synchronous signal HD has the “H” level), and the pixel signals of the pixels in the selected ninth, tenth columns in the pixels P11 to Pm1 of the first row are output from an output channel CH1 via horizontal selection switches 11-9, 11-10.

Moreover, since the row to read differs with each frame, the pixel reset signal V1r is set to the “H” level again at a predetermined timing (using an electronic shutter), and the pixels are reset (reset in the first, fourth, seventh rows in this example) in order to set the accumulation time to be uniform.

Thereafter, the pixels (the respective ninth, tenth columns) of all the rows are similarly successively selected in the horizontal blanking period, pixel signals of the selected columns (the respective ninth, tenth columns) for each row are output in the horizontal valid period, and accordingly reading is performed as shown in FIG. 8.

In the second frame, the whole region decimation signal is read as shown in FIG. 5. Since this has been described in the first embodiment, a repetitive description is omitted.

The reading of the middle portion continuous signal, and the reading of the whole region decimation signal are alternately repeated for each frame.

According to the second embodiment described above, a certain degree of resolution can be achieved both in horizontal and vertical directions. Furthermore, in the case of the high pixels, when the pixel signals are output simultaneously, a problem occurs in a frame rate. However, since the reading of the whole region decimation signal (e.g., for display), and the reading of the middle portion continuous signal (e.g., for AF) are alternately repeated for each frame according to the present embodiment, outputs are easily obtained in accordance with use applications.

### THIRD EMBODIMENT

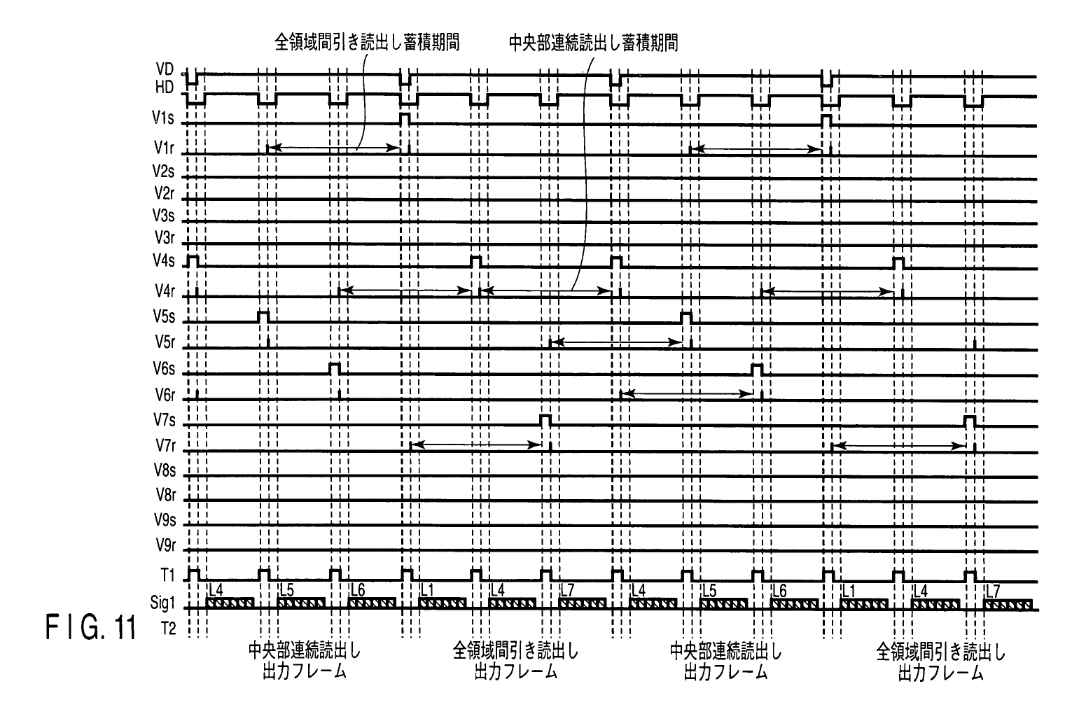

A solid-state image sensing apparatus according to a third embodiment of the present invention will be described hereinafter in detail with reference to FIGS. 10 and 11. It is to be noted that FIG. 10 shows a reading pattern example of a middle portion continuous signal, and FIG. 11 is a timing chart showing timings for alternately reading pixels for each frame in a mode shown in FIGS. 5, 10 in detail. FIG. 5 is hereinafter appropriately referred to.

In the solid-state image sensing apparatus according to the third embodiment, the middle portion continuous signal is read in a first frame as shown in FIG. 10, a whole region decimation signal is read in a second frame, and subsequently this is alternately repeated for each frame. In this case, since rows to read differ with frames, a pixel reset signal V1r is set to an “H” level at a predetermined timing (using an electronic shutter), and pixels are reset in order to set an accumulation time to be uniform. Here, it is assumed that the period of the frame is not changed, and further a phase of a horizontal synchronous signal HD is common in each frame.

A characteristic reading operation by the solid-state image sensing apparatus according to the third embodiment will be described hereinafter in further detail with reference to the timing chart of FIG. 11.

VD denotes a vertical synchronous signal, HD denotes a horizontal synchronous signal, V1s, V2s, . . . denote pixel selection signals, V1r, V2r, . . . denote pixel reset signals, CKT is a clock input into a transfer switch, and an output is a pixel signal output from an output channel.

The middle portion continuous signal is read in the first frame as shown in FIG. 10.

A vertical scanning circuit 30 first scans the fourth row along an arrangement direction of units 30-1, 30-2, . . . , 30-n. That is, when a pixel selection signal V4s output from the vertical scanning circuit 30 turns to an “H” level in a horizontal blanking period (period in which a horizontal synchronous signal HD has an “L” level), pixels P14 to Pm4 of the fourth row are selected. In this period, since the clock CKT input into transfer switches 13-1 to 13-m has the “H” level, pixel signals of the selected pixels P14 to Pm4 are stored in line memories 12-1 to 12-m. Thereafter, the pixel reset signal V4r turns to the “H” level, and charges of the pixels P14 to Pm4 are reset.

Thereafter, units 10-7 to 10-12 of a horizontal scanning circuit 10 output horizontal selection signals in a horizontal valid period (period in which the horizontal synchronous signal HD has the “H” level), and the pixel signals of the pixels in the selected seventh to 12-th columns in the pixels P14 to Pm4 of the fourth row are output from an output channel CH1 via horizontal selection switches 11-7 to 11-12.

Moreover, since the row to read differs with each frame, the pixel reset signal V4r is set to the “H” level again at a predetermined timing (using an electronic shutter), and the pixels are reset (reset in the fourth to sixth rows in this example) in order to set the accumulation time to be uniform.

Thereafter, the pixels (the respective seventh to 12-th columns) of the fifth, sixth rows are similarly successively selected in the horizontal blanking period, pixel signals of the selected columns (the respective seventh to 12-th columns) for each row are output in the horizontal valid period, and accordingly reading is performed as shown in FIG. 10.

In the second frame, the whole region decimation signal is read as shown in FIG. 5. Since this has been described in the first embodiment, a repetitive description is omitted.

The reading of the middle portion continuous signal, and the reading of the whole region decimation signal are alternately repeated for each frame.

According to the third embodiment described above, a certain degree of resolution can be achieved both in horizontal and vertical directions. Furthermore, in the case of the high pixels, when the pixel signals are output at once, a problem occurs in a frame rate. However, since the reading of the whole region decimation signal (e.g., for display), and the reading of the middle portion continuous signal (e.g., for AF) are alternately repeated for each frame according to the present embodiment, outputs are easily obtained in accordance with use applications.

### FOURTH EMBODIMENT

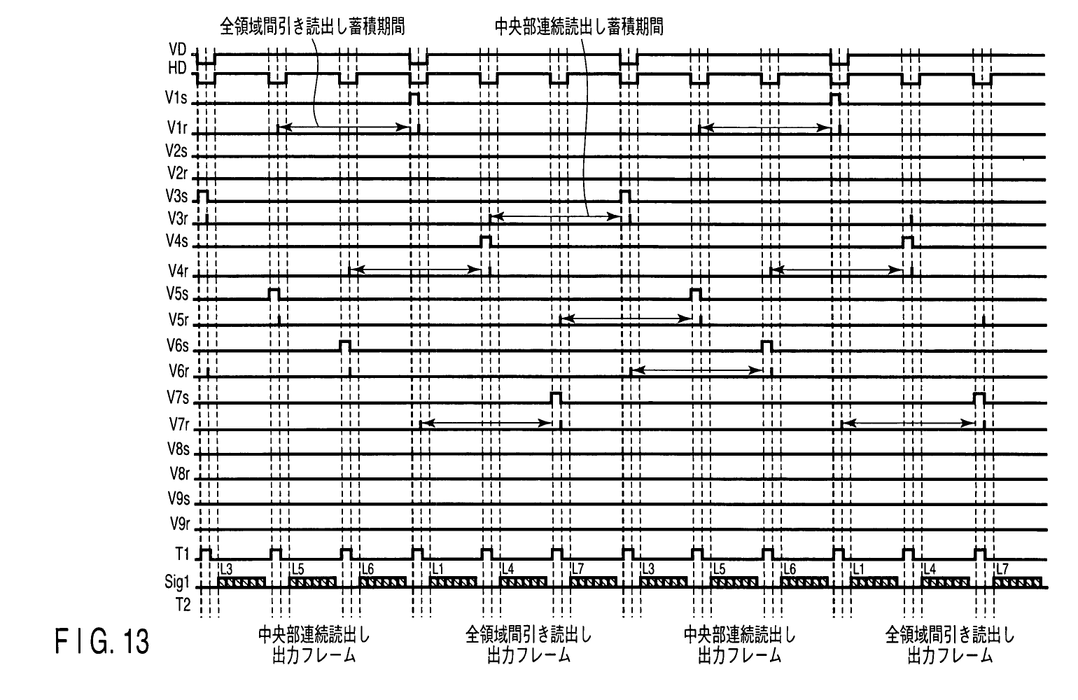

A solid-state image sensing apparatus according to a fourth embodiment of the present invention will be described hereinafter in detail with reference to FIGS. 12, 13. It is to be noted that FIG. 12 shows a reading pattern example of a middle portion continuous signal, and FIG. 13 is a timing chart showing timings for alternately reading pixels for each frame in a mode shown in FIGS. 5, 12 in detail. FIG. 5 is hereinafter appropriately referred to.

In the solid-state image sensing apparatus according to the fourth embodiment, the middle portion continuous signal is read in a first frame as shown in FIG. 12, a whole region decimation signal is read in a second frame, and subsequently this is alternately repeated for each frame. In this case, pixels of reading objects are sometimes superimposed in reading the middle portion continuous signal and the whole region decimation signal. When the pixels are the same, no problem occurs because the pixels shift by a frame unit. However, since a reading order differs, the shift cannot be controlled by an electronic shutter in some case. Therefore, the corresponding line is ignored in the same line, and superimposed portions are not used. This is one of characteristics of the present embodiment.

A characteristic reading operation by the solid-state image sensing apparatus according to the fourth embodiment will be described hereinafter in further detail with reference to the timing chart of FIG. 13.

VD denotes a vertical synchronous signal, HD denotes a horizontal synchronous signal, V1s, V2s, . . . denote pixel selection signals, V1r, V2r, . . . denote pixel reset signals, CKT is a clock input into a transfer switch, and an output is a pixel signal output from an output channel.

The middle portion continuous signal is read in the first frame as shown in FIG. 12.

A vertical scanning circuit 30 first scans the third row along an arrangement direction of units 30-1, 30-2, . . . , 30-n. That is, when a pixel selection signal V3s output from the vertical scanning circuit 30 turns to an “H” level in a horizontal blanking period (period in which a horizontal synchronous signal HD has an “L” level), pixels P13 to Pm3 of the third row are selected. In this period, since the clock CKT input into transfer switches 13-1 to 13-m has the “H” level, pixel signals of the selected pixels P13 to Pm3 are stored in line memories 12-1 to 12-m. Thereafter, the pixel reset signal V3r turns to the “H” level, and charges of the pixels P13 to Pm3 are reset.

Thereafter, units 10-7 to 10-12 of a horizontal scanning circuit 10 output horizontal selection signals in a horizontal valid period (period in which the horizontal synchronous signal HD has the “H” level), and the pixel signals of the pixels in the selected seventh to 12-th columns in the pixels P13 to Pm3 of the third row are output from an output channel CH1 via horizontal selection switches 11-7 to 11-12.

Moreover, since the row to read differs with each frame, the pixel reset signal V3r is set to the “H” level again at a predetermined timing (using the electronic shutter), and the pixels are reset (reset in the third, fifth, sixth rows in this example) in order to set the accumulation time to be uniform.

Thereafter, the pixels (the respective seventh to 12-th columns) of the fifth, sixth rows are similarly successively selected in the horizontal blanking period, pixel signals of the selected columns (the respective seventh to 12-th columns) for each row are output in the horizontal valid period, and accordingly reading is performed as shown in FIG. 12.

In the second frame, the whole region decimation signal is read as shown in FIG. 5. Since this has been described in the first embodiment, a repetitive description is omitted.

According to the fourth embodiment described above, a certain degree of resolution can be achieved both in horizontal and vertical directions. Furthermore, in the case of the high pixels, when the pixel signals are output at once, a problem occurs in a frame rate. However, since the reading of the whole region decimation signal (e.g., for display), and the reading of the middle portion continuous signal (e.g., for AF) are alternately repeated for each frame according to the present embodiment, outputs are easily obtained in accordance with use applications.

In the first to fourth embodiments of the present invention, the operations for performing the decimation scanning of the horizontal and vertical scanning circuits have been described. However, to perform the operations, the use of a decoder circuit or the use of a shift register in a scanning circuit can be realized in a decimation scanning method described, for example, in Jpn. Pat. Appln. KOKAI Publication No. 9-163245, and, needless to say, all the pixels can be successively read by performing the successive scanning.

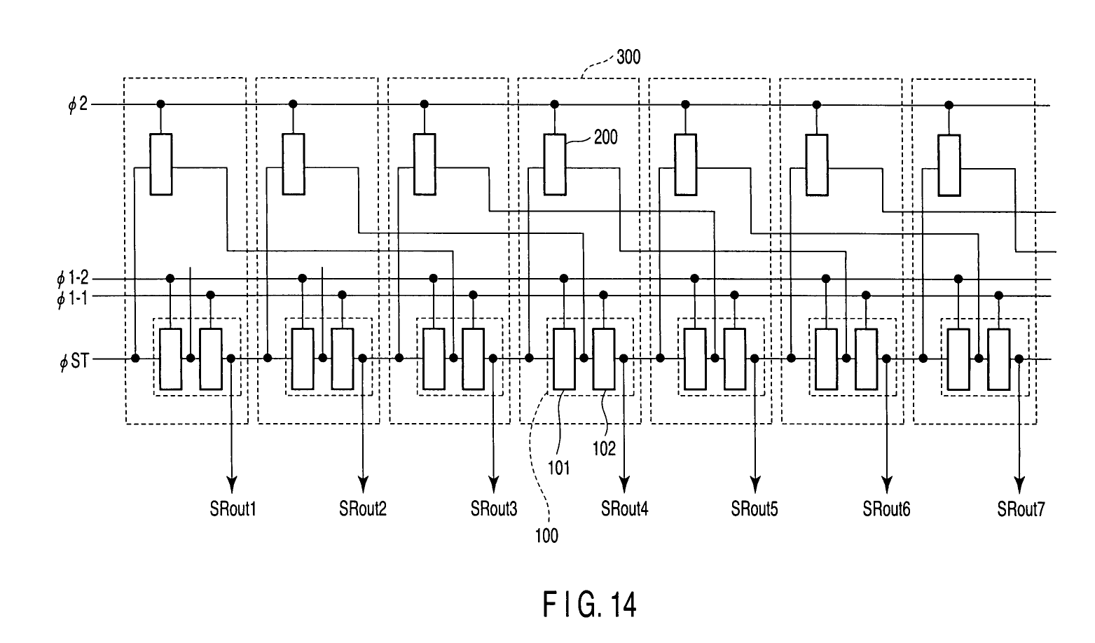

Here, FIG. 14 shows a constitution example of a shift register for use in a scanning circuit for performing successive scanning and decimation scanning. The example will be described.

Here, an example of ⅓ decimation scanning will be described.

In FIG. 14, a shift register unit 300 for one stage comprises a first shift register unit 100 comprising sub-units 101 and 102, and a second shift register unit 200. Input ends of the first and second shift register units 100 and 200 are connected in common. An output end of the first shift register unit 100 is connected to an input end of the shift register unit of the next stage, and an output end of the second shift register unit 200 is connected to the input end of the sub-unit 102 two stages behind. Moreover, the sub-units 101 and 102 of the first shift register unit are driven by driving pulses φ1-1, φ1-2, respectively, and the second shift register unit 200 is driven by a driving pulse φ2.

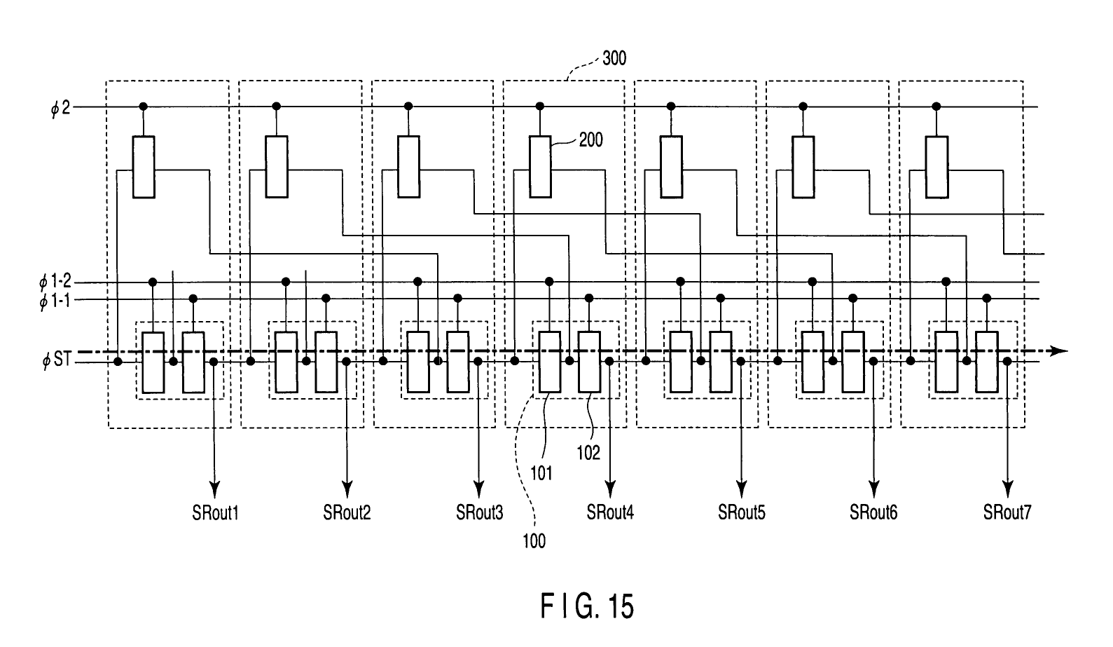

In the shift register constituted in this manner, driving signals are applied to the driving pulses φ1-1, φ1-2, and the driving pulse φ2 is brought into a state in which the second shift register unit 200 is inoperative. When a start pulse φST of the shift register is input, an input signal shifts in the shift register as shown by a one-dot chain line in FIG. 15. Therefore, the shift register outputs signals SRout1, SRout2, SRout3, . . . in this order, and successive scanning is performed.

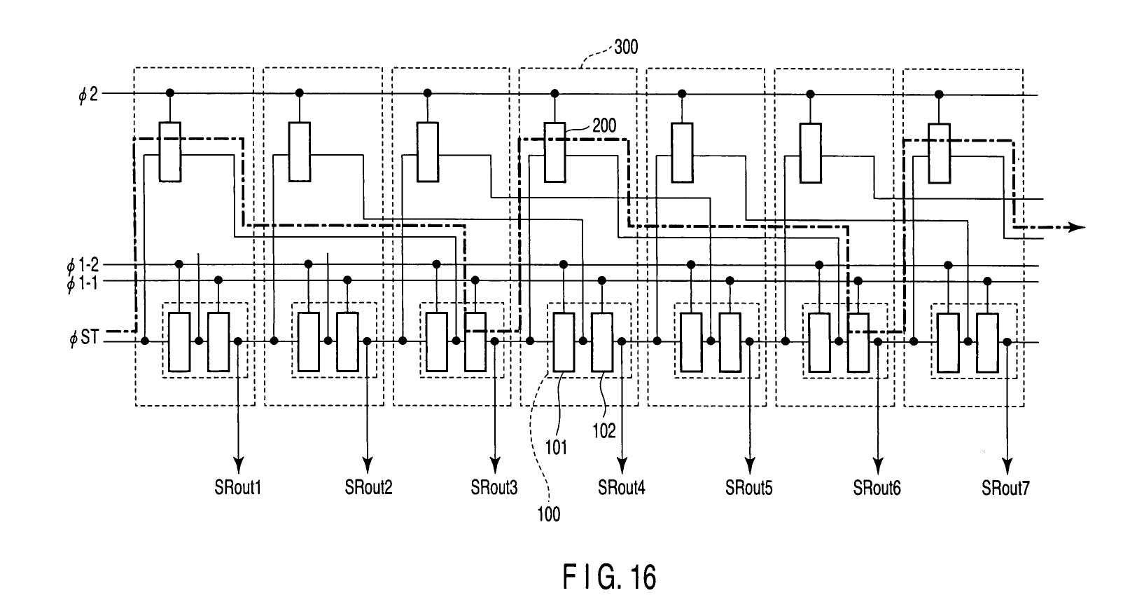

On the other hand in this shift register, driving signals are applied to the driving pulses φ1-1, φ2, and a driving pulse φ1-2 is brought into a state in which the sub-unit 101 is inoperative. When a start pulse φST of the shift register is input, an input signal shifts in the shift register as shown by a one-dot chain line in FIG. 16. Therefore, the shift register outputs signals Srout3, Srout6, . . . in this order, and ⅓ decimation scanning is performed.

As described above, the shift register constituted as shown in FIG. 14 is used in the scanning circuit, the driving pulse is controlled, and accordingly the successive scanning and decimation scanning can be switched. It is to be noted that the successive scanning and the decimation scanning can be switched by control of the driving pulse. Therefore, when the driving pulse is changed in the middle of the scanning, the successive scanning and the decimation scanning can be switched during the scanning, the successive scanning is performed in a shielding pixel region, and the decimation scanning is performed in a valid pixel region. This scanning is also possible.

According to the first to fourth embodiments of the present invention, there can be provided a solid-state image sensing apparatus in which high-speed reading at an enhanced frame rate, and low power consumption are realized while maintaining a simple constitution and which is capable of alternately reading a plurality of types of signals in accordance with use applications.

Next, fifth to eighth embodiments of the present invention will be described.

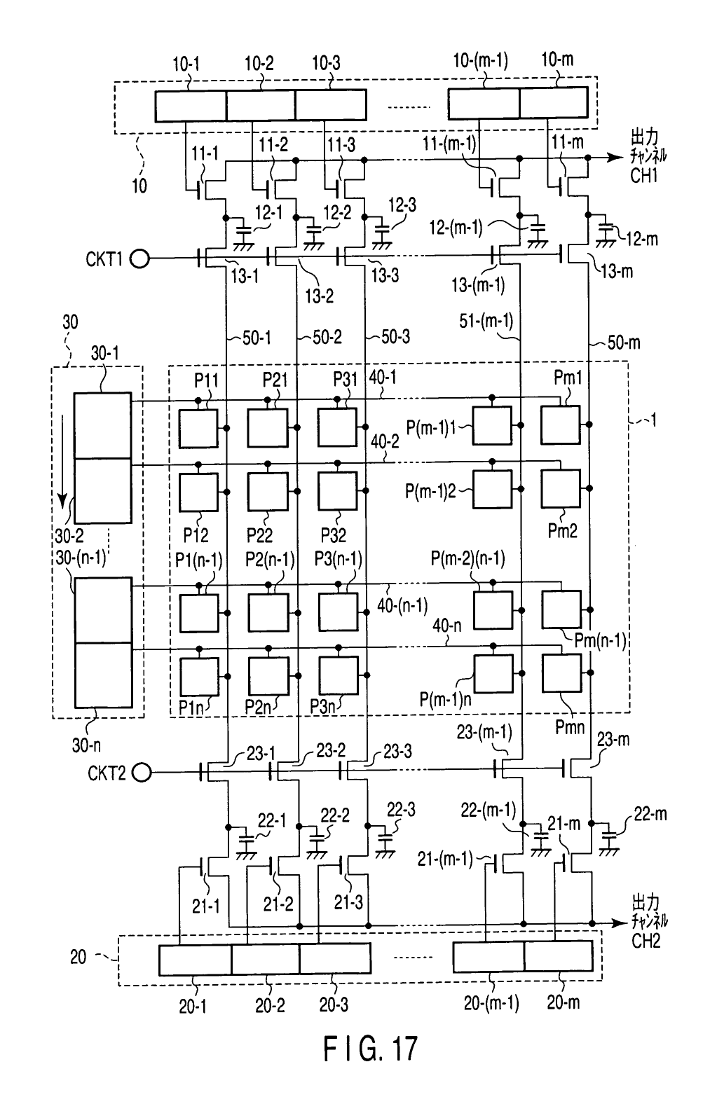

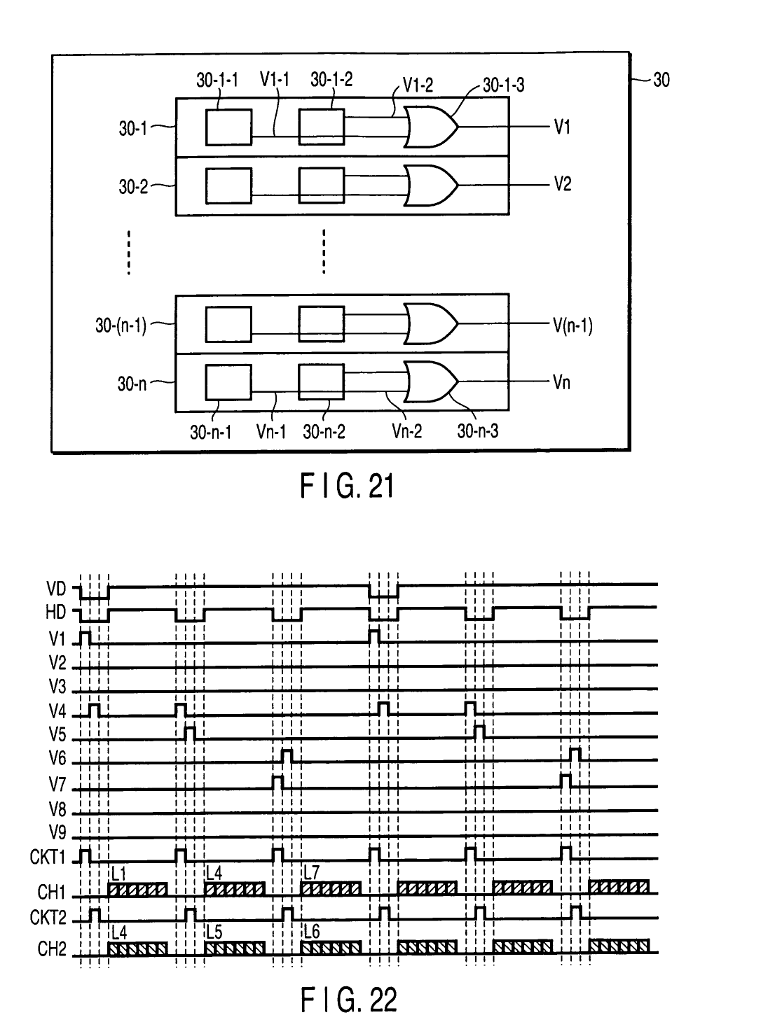

First, FIG. 17 shows a constitution of a solid-state image sensing apparatus common to the fifth to the eighth embodiments of the present invention. This constitution will be described in detail. Additionally, as described later in detail, in the seventh, eighth embodiments, a constitution shown in FIG. 21 is adopted as a vertical scanning circuit 30.

In FIG. 17, symbols P11 to Pmn (m, n are natural numbers) show m×n pixels two-dimensionally arranged in a matrix (matrix arrangement).

A solid-state image sensing apparatus (photoelectric conversion unit) 1 comprises the plurality of pixels P11 to Pmn.

A vertical scanning circuit 30 successively scans lines 40-1 to 40-n, and comprises a plurality of units 30-1 to 30-n corresponding to the respective lines 40-1 to 40-n.

Horizontal scanning circuits 10, 20 successively read electric signals derived to output signal lines 50-1 to 50-m from the respective pixels P11 to Pmn for each pixel in a horizontal direction.

The horizontal scanning circuits 10, 20 comprise a plurality of units 10-1 to 10-m, 20-1 to 20-m corresponding to the respective output signal lines 50-1 to 50-m.

It is to be noted that the respective pixels P11 to Pmn are also connected to lines other than the lines 40-1 to 40-n and the output signal lines 50-1 to 50-m, but the lines are omitted from the drawing here.

Moreover, on one end of each of the output signal lines 50-1 to 50-m on the side of the horizontal scanning circuit 10, a set of each of transistors 13-1 to 13-m, line memories 12-1 to 12-m, and transistors 11-1 to 11-m is disposed as shown.

On the other hand, on the other end of each of the output signal lines 50-1 to 50-m on the side of the horizontal scanning circuit 20, a set of each of transistors 23-1 to 23-m, line memories 22-1 to 22-m, and transistors 21-2 to 21-m is disposed as shown.

The transistors 13-1 to 13-m, 23-1, 23-m have functions of transfer switches for transferring signals of a pixel row selected by the vertical scanning circuit 30 to the line memories 12-1 to 12-m, 22-1 to 22-m, and are constituted to be controlled to be on/off by clocks CKT1, CKT2 for control (the transistors 13-1 to 13-m, 23-1, 23-m will be hereinafter referred to as the “transfer switches”).

Furthermore, the line memories 12-1 to 12-m, 22-1 to 22-m comprise capacity devices for temporarily storing pixel signals transferred from the pixels P11 to Pmn via the transfer switches 13-1 to 13-m, 23-1 to 23-m. The transistors 11-1 to 11-m, 21-1 to 21-m have functions of horizontal selection switches for selecting the pixel signals stored in the line memories 12-1 to 12-m, 22-1 to 22-m.

The transistors 11-1 to 11-m, 21-1 to 21-m are constituted to be controlled to be on/off by output signals of the horizontal scanning circuits 10, 20 (the transistors 11-1 to 11-m, 21-1 to 21-m will be hereinafter referred to as the “horizontal selection switches”).

Additionally, an output channel CH1 for reading the pixel signal via the horizontal selection switches 11-1 to 11-m, and an output channel CH2 for reading the pixel signals via the horizontal selection switches 21-2 to 21-m are disposed.

It is to be noted that transfer signals described in claims correspond to the clocks CKT1, CKT2, transfer switches correspond to the transfer switches 13-1 to 13-m, 23-1 to 23-m and the like, line memories correspond to the line memories 12-1 to 12-m, 22-1 to 22-m and the like, horizontal scanning circuits correspond to the horizontal scanning circuits 10, 20 and the like, and a plurality of output channels correspond to CH1, CH2 and the like. First and second transfer signals described in claims correspond to the clocks CKT1, CKT2, first and second transfer switches correspond to the transfer switches 13-1 to 13-m, 23-1 to 23-m and the like, first and second line memories correspond to the line memories 12-1 to 12-m, 22-1 to 22-m and the like, first and second horizontal scanning circuits correspond to the horizontal scanning circuits 10, 20 and the like, and first and second output channels correspond to CH1, CH2 and the like.

Here, a constitution example of the respective pixels P11 to Pmn is shown in FIG. 2, and a timing chart relating to a state of each signal is shown in FIG. 3. Here, a repetitive description is omitted. In the fifth to eighth embodiments of the present invention, all the pixels P11 to Pmn can be successively read by the above-described constitution and function, and decimation reading is also possible.

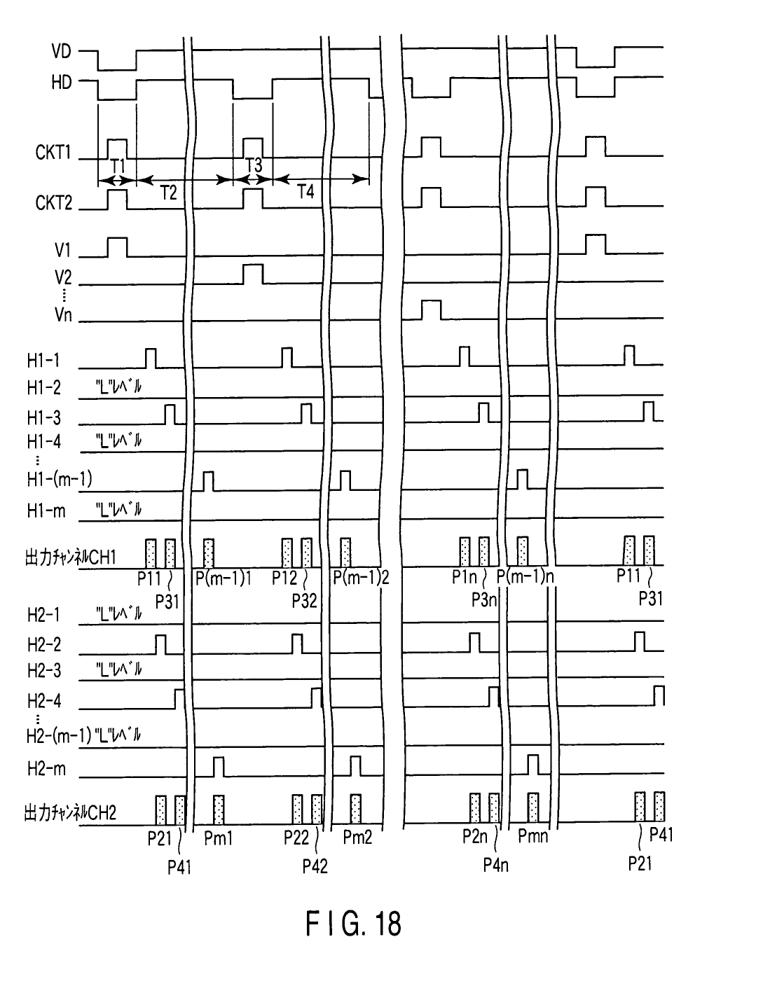

The successive reading of all the pixels P11 to Pmn of the solid-state image sensing apparatus according to the fifth to eighth embodiments constituted as described above will be described hereinafter with reference to a timing chart of FIG. 18.

First, prior to operation description, meanings/contents of symbols for use in FIG. 18 are defined. In FIG. 18, VD means a vertical synchronous signal, and HD means a horizontal synchronous signal. CKT1 means a transfer signal for controlling the transfer switches 13-1 to 13-m to be on/off. CKT2 means a transfer signal for controlling the transfer switches 22-1 to 22-m to be on/off.

V1 to Vn mean row selection signals output from the vertical scanning circuit 30. H1-1 to H1-m mean horizontal selection signals which are output from the respective units 10-1 to 10-m of the horizontal scanning circuit 10 and which control the horizontal selection switches 11-1 to 11-m. H2-1 to H2-m mean horizontal selection signals which are output from the respective units 20-1 to 20-m of the horizontal scanning circuit 20 and which control the horizontal selection switches 21-1 to 21-m. Additionally, CH1, CH2 also mean pixel signals output from the respective output channels.

First, when the row selection signal V1 turns to an “H” level in a horizontal blanking period T1, the pixels P11 to Pm1 of the first row are selected. In this period, the transfer signals CKT1 and CKT2 have “H” levels. Therefore, the pixel signals of the pixels P11 to Pm1 of the first row are stored in the line memories 12-1 to 12-m, 22-1 to 22-m. Thereafter, the horizontal scanning circuits 10, 20 are operated in a horizontal valid period T2. In the horizontal scanning circuit 10, horizontal selection signals H1-1, H1-2, . . . , H1-(m-1) are output only from odd-numbered horizontal scanning circuit units 10-1, 10-3, . . . 10-(m-1) in order. Synchronously with the outputs, the pixel signals of the pixels P11, P31, . . . , P(m-1)1 stored in odd-numbered line memories 12-1, 12-3, . . . , 12-(m-1) are successively output from the output channel CH1. In the horizontal scanning circuit 20, horizontal selection signals H2-2, H2-4, . . . , H2-m are output only from even-numbered horizontal scanning circuit units 20-2, 20-4, . . . , 20-m in order. Synchronously with the outputs, the pixel signals of the pixels P21, P41, . . . , Pm1 stored in even-numbered line memories 22-2, 22-4, . . . , 22-m are successively output from the output channel CH2.

Subsequently, when the row selection signal V2 turns to the “H” level in the next horizontal blanking period T3, the pixels P12 to Pm2 of the second row are selected. In this period, the transfer signals CKT1 and CKT2 have “H” levels. Therefore, the pixel signals of the selected pixels P12 to Pm2 are stored in the line memories 12-1 to 12-m, 22-1 to 22-m. Thereafter, the horizontal scanning circuits 10, 20 are operated in a horizontal valid period T4. In the horizontal scanning circuit 10, horizontal selection signals H1-1, H1-2, . . . , H1-(m-1) are output only from odd-numbered horizontal scanning circuit units 10-1, 10-3, . . . 10-(m-1) in order. Synchronously with the outputs, the pixel signals of the pixels P12, P32, . . . , P(m-1)2 stored in odd-numbered line memories 12-1, 12-3, 12-(m-1) are successively output from the output channel CH1. In the horizontal scanning circuit 20, horizontal selection signals H2-2, H2-4, . . . , H2-m are output only from even-numbered horizontal scanning circuit units 20-2, 20-4, . . . , 20-m in order. Synchronously with the outputs, the pixel signals of the pixels P22, P42, . . . , Pm2 stored in even-numbered line memories 22-2, 22-4, . . . , 22-m are successively output from the output channel CH2.

Thereafter, in the same manner as described above, the pixels of third to n-th rows are selected in the horizontal blanking period, odd-numbered column pixel signals among the pixel signals are output from the output channel CH1 in the horizontal valid period, and even-numbered column pixel signals are output from the output channel CH2. It is to be noted that an operation timing of the horizontal scanning circuit 20 shifts from that of the horizontal scanning circuit 10 by 180 degrees. Therefore, when the pixel signals output from the output channels CH1 and CH2 are mixed later, a process can be securely performed.

It is to be noted that here all the pixel signals are output using both the output channels CH1 and CH2, but all the pixel signals may be read using only one of them.

Characteristic operations of the fifth to eighth embodiments will be described hereinafter in detail on the assumption of the above-described constitution and function of the solid-state image sensing apparatus.

### FIFTH EMBODIMENT

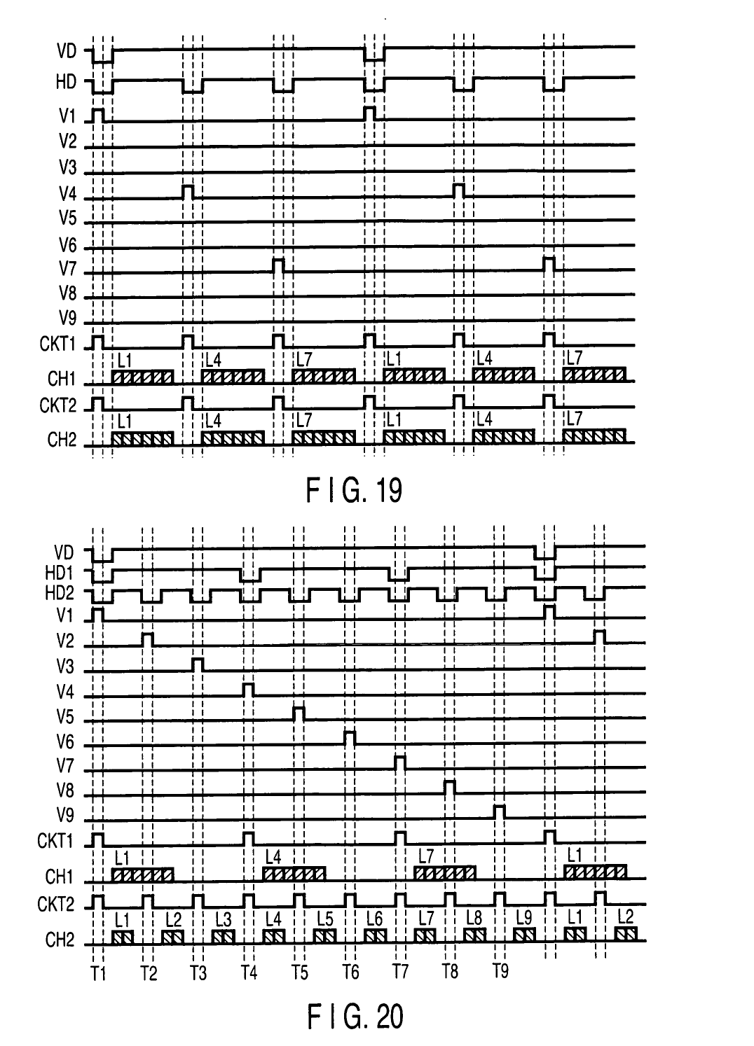

A solid-state image sensing apparatus according to a fifth embodiment of the present invention will be described hereinafter in detail with reference to FIGS. 5, 6, and 19. It is to be noted that as described above FIG. 5 shows a reading pattern example of a whole region decimation signal, FIG. 6 shows a reading pattern example of a middle portion continuous signal, and FIG. 19 is a timing chart showing timings for reading these signal simultaneously in one frame.

In the solid-state image sensing apparatus according to the fifth embodiment, the reading of the middle portion continuous signal and the reading of the whole region decimation signal shown in FIGS. 5, 6 are simultaneously performed. At this time, rows selected in reading the middle portion continuous signal and rows selected in reading the whole region decimation signal are common (first, fourth, seventh rows are selected in order in this example). Furthermore, with regard to each row, signals only of pixels (seventh to 12-th columns in this example) of a middle portion are read as the middle portion continuous signals, and signals of pixels from which two pixels are decimated (first, fourth, seventh, tenth, 13-th, 16-th columns in this example) are read as the whole region decimation signals.

A characteristic reading operation by the solid-state image sensing apparatus according to the fifth embodiment will be described hereinafter in further detail with reference to the timing chart of FIG. 19.

First, prior to operation description, meanings/contents of symbols for use in FIG. 19 are defined. In FIG. 19, VD means a vertical synchronous signal, and HD means a horizontal synchronous signal. CKT1, 2 mean transfer signals for controlling the transfer switches 13-1 to 13-m, 23-1 to 23-m to be on/off. V1 to Vn (here n=9) mean row selection signals output from the vertical scanning circuit 30. Additionally, CH1, CH2 also mean pixel signals output from the respective output channels.

When the operation starts, the vertical scanning circuit 30 first scans the first row along an arrangement direction of units 30-1, 30-2, . . . , 30-n. That is, when the row selection signal V1 output from the vertical scanning circuit 30 turns to an “H” level in a horizontal blanking period (period in which a horizontal synchronous signal HD has an “L” level), pixels P11 to Pm1 of a first row are selected.

In this period, since the clocks CKT1, CKT2 input into transfer switches 13-1 to 13-m, 23-1 to 23-m have the “H” levels, pixel signals of the selected pixels P11 to Pm1 are stored in line memories 12-1 to 12-m and 22-1 to 22-m.

Thereafter, units 10-1, 10-4, 10-7, 10-10, 10-13, 10-16 among the respective units of the horizontal scanning circuit 10 output horizontal selection signals in a horizontal valid period (period in which the horizontal synchronous signal HD has the “H” level), and the pixel signals of the pixels in the selected first, fourth, seventh, tenth, 13-th, 16-th columns in the pixels P11 to Pm1 of the first row are output from an output channel CH1 via horizontal selection switches 11-1, 11-4, 11-7, 11-10, 11-13, 11-16. Simultaneously, units 20-7 to 20-12 among the respective units of the horizontal scanning circuit 20 output horizontal selection signals in a horizontal valid period (period in which the horizontal synchronous signal HD has the “H” level), and the pixel signals of the pixels in the selected seventh to 12-th columns in the pixels P11 to Pm1 of the first row are output from an output channel CH2 via horizontal selection switches 21-7 to 21-12.

Thereafter, the pixels of the fourth and seventh rows are successively selected similarly in the horizontal blanking period, the pixel signals of the selected columns (first, fourth, seventh, tenth, 13-th, 16-th columns, and seven to 12-th columns) for each row are output in the horizontal valid period, and accordingly the reading shown in FIGS. 5, 6 is simultaneously performed.

According to the fifth embodiment described above, in the case of the high pixels, when the pixel signals are output simultaneously, a problem occurs in a frame rate. However, since the reading of the whole region decimation signal (e.g., for display), and the reading of the middle portion continuous signal (e.g., for AF) are simultaneously performed from different output channels in one frame, outputs are easily obtained in accordance with use applications.

### SIXTH EMBODIMENT

A solid-state image sensing apparatus according to a sixth embodiment of the present invention will be described hereinafter in detail with reference to FIGS. 8 and 20. It is to be noted that as described above FIG. 8 shows a reading pattern example of a middle portion continuous signal, and FIG. 20 is a timing chart showing timings for reading the signal shown in FIGS. 5, 8 simultaneously in one frame. FIG. 5 is hereinafter appropriately referred to.

In the solid-state image sensing apparatus according to the sixth embodiment, the reading of the middle portion continuous signal and the reading of the whole region decimation signal shown in FIG. 8 are simultaneously performed in one frame. At this time, in the reading of the middle portion continuous signal, a middle portion (ninth, tenth columns) is read in a vertical direction without any decimation.

A characteristic reading operation by the solid-state image sensing apparatus according to the sixth embodiment will be described hereinafter in further detail with reference to the timing chart of FIG. 20.

First, prior to operation description, meanings/contents of symbols for use in FIG. 20 are defined.

In FIG. 20, VD means a vertical synchronous signal. HD1 means a horizontal synchronous signal for the whole region decimation signal, and HD2 means a horizontal synchronous signal for the middle portion continuous signal. Moreover, CKT1, 2 mean transfer signals for controlling the transfer switches 13-1 to 13-m, 23-1 to 23-m to be on/off. V1 to Vn (here n=9) mean row selection signals output from the vertical scanning circuit 30. Additionally, CH1, CH2 also mean pixel signals output from the respective output channels.

When the operation starts, the vertical scanning circuit 30 first scans the first row along an arrangement direction of units 30-1, 30-2, . . . , 30-n. That is, when the row selection signal V1 output from the vertical scanning circuit 30 turns to an “H” level in a period T1, pixels P11 to Pm1 of a first row are selected.

In this period, since the clocks CKT1, CKT2 input into transfer switches 13-1 to 13-m, 23-1 to 23-m have the “H” levels, pixel signals of the selected pixels P11 to Pm1 are stored in line memories 12-1 to 12-m and 22-1 to 22-m.

Thereafter, units 10-1, 10-4, 10-7, 10-10, 10-13, 10-16 among the respective units of the horizontal scanning circuit 10 output horizontal selection signals in a horizontal valid period (period in which HD1 has the “H” level) in the whole region decimation signal, and the pixel signals of the pixels in the selected first, fourth, seventh, tenth, 13-th, 16-th columns in the pixels P11 to Pm1 of the first row are output from an output channel CH1 via horizontal selection switches 11-1, 11-4, 11-7, 11-10, 11-13, 11-16. On the other hand, units 20-9, 20-10 among the respective units of the horizontal scanning circuit 20 output horizontal selection signals in the horizontal scanning circuit 20, and the pixel signals of the pixels in the selected ninth, tenth columns in the pixels P11 to Pm1 of the first row are output from an output channel CH2 via horizontal selection switches 21-9, 21-10.

Next, the vertical scanning circuit 30 scans the second row along the arrangement direction of the respective units 30-1, 30-2, . . . , 30-n. That is, when a row selection signal V2 output from the vertical scanning circuit 30 turns to the “H” level in a period T2, pixels P12 to Pm2 of the second row are selected.

In this period, since the clock CKT1 input into transfer switches 13-1 to 13-m, 23-1 to 23-m have the “L” level, and CKT2 have the “H” level, pixel signals of the selected pixels P12 to Pm2 are stored only in line memories 22-1 to 22-m. Thereafter, 20-9, 20-10 among the respective units of the horizontal scanning circuit 20 output horizontal selection signals, and the pixel signals of the pixels of the selected ninth, tenth columns among the pixels P12 to Pm2 of the second row are output from the output channel CH2 via horizontal selection switches 21-9 to 21-10.

With regard to the third row, in the same manner as in the second row, the pixel signals of the ninth, tenth column are read only from the output channel CH2. In and after the fourth row, an operation similar to that of the first to third rows is repeated. Therefore, with regard to the fourth, seventh rows, the pixel signals of the first, fourth, seventh, tenth, 13-th, 16-th columns are read from the output channel CH1, and the pixel signals of the ninth, tenth columns are read from the output channel CH2. With regard to fifth, sixth, eight, ninth rows, the pixel signals of the ninth, tenth columns are read only from the output channel CH2, and the reading shown in FIGS. 5, 8 is performed simultaneously in one frame.

According to the sixth embodiment described above, a certain degree of resolution can be achieved both in horizontal and vertical directions. Furthermore, in the case of the high pixels, when the pixel signals are output at once, a problem occurs in a frame rate. However, since the reading of the whole region decimation signal (e.g., for display), and the reading of the middle portion continuous signal (e.g., for AF) are simultaneously performed from different output channels in one frame according to the present embodiment, outputs are easily obtained in accordance with use applications.

### SEVENTH EMBODIMENT

A solid-state image sensing apparatus according to a seventh embodiment of the present invention will be described hereinafter in detail with reference to FIGS. 21, 10, 22. It is to be noted that FIG. 21 shows a constitution example of a vertical scanning circuit 30 adopted in the solid-state image sensing apparatus according to the seventh embodiment, FIG. 10 shows a reading pattern example of a middle portion continuous signal, and FIG. 22 is a timing chart showing timings for reading the signal shown in FIGS. 5, 8 simultaneously in one frame. FIG. 5 is hereinafter appropriately referred to.

In the solid-state image sensing apparatus according to the seventh embodiment, the reading of the middle portion continuous signal and the reading of the whole region decimation signal shown in FIG. 10 are simultaneously performed in one frame.

Here, the vertical scanning circuit 30 shown in FIG. 21 is constituted of units 30-1, . . . , 30-n which select/output one of V1-1 or V1-2, . . . Vn-1 or Vn-2 as row selection signals V1 to Vn. For example, the unit 30-1 is constituted of sub-units 30-1-1 and 30-1-2, and an OR circuit 30-1-3, and either an output V1-1 of the sub-unit 30-1-1 or an output V1-2 of the sub-unit 30-1-2 is selected by the OR circuit 30-1-3, and output as the row selection signal V1.

A characteristic reading operation by the solid-state image sensing apparatus according to the seventh embodiment will be described hereinafter in further detail with reference to the timing chart of FIG. 22.

First, prior to operation description, meanings/contents of symbols for use in FIG. 22 are defined.

In FIG. 22, VD means a vertical synchronous signal. HD means a horizontal synchronous signal. CKT1, 2 mean transfer signals for controlling the transfer switches 13-1 to 13-m, 23-1 to 23-m to be on/off. V1 to Vn (here n=9) mean row selection signals output from the vertical scanning circuit 30. Additionally, CH1, CH2 also mean pixel signals output from the respective output channels.

When the operation starts, the vertical scanning circuit 30 first scans the first row along an arrangement direction of units 30-1, 30-2, . . . , 30-n. That is, when the row selection signal V1 output from the vertical scanning circuit 30 turns to an “H” level in a horizontal blanking period (period in which the horizontal synchronous signal HD has an “L” level), pixels P11 to Pm1 of a first row are selected.

In this period, since the clock CKT1 input into transfer switches 13-1 to 13-m have the “H” levels, pixel signals of the selected pixels P11 to Pm1 are stored in line memories 12-1 to 12-m. Thereafter, units 10-1, 10-4, 10-7, 10-10, 10-13, 10-16 among the respective units of the horizontal scanning circuit 10 output horizontal selection signals in a horizontal valid period (period in which the horizontal synchronous signal HD has the “H” level), and the pixel signals of the pixels in the selected first, fourth, seventh, tenth, 13-th, 16-th columns in the pixels P11 to Pm1 of the first row are output from an output channel CH1 via horizontal selection switches 11-1, 11-4, 11-7, 11-10, 11-13, 11-16.

Moreover, the vertical scanning circuit 30 scans the fourth row along the arrangement direction of the respective units 30-1, 30-2, . . . , 30-n in the same horizontal blanking period. That is, when a row selection signal V4 output from the vertical scanning circuit 30 turns to the “H” level, pixels P14 to Pm4 of the fourth row are selected.

In this period, since the clock CKT2 input into transfer switches 23-1 to 23-m has the “H” level, the pixel signals of the selected pixels P14 to Pm4 are stored in line memories 22-1 to 22-m.

Thereafter, 20-7 to 20-12 among the respective units of the horizontal scanning circuit 20 output horizontal selection signals in a horizontal valid period (period in which the horizontal synchronous signal HD has the “H” level), and the pixel signals of the pixels of the selected seventh to 12-th columns among the pixels P14 to Pm4 of the fourth row are output from the output channel CH2 via horizontal selection switches 21-7 to 21-12.

The seventh embodiment is characterized in that a timing of the reading of the middle portion continuous signal is shifted from that of the reading of the whole region decimation signal (timing for setting the transfer signals CKT1, CKT2 to the “H” level) in order to prevent the pixel signals of the vertical signal line from being mixed with each other. Thereafter, the pixel signals of the fourth and fifth, seventh and sixth rows are similarly simultaneously read from CH1, CH2, and accordingly the reading shown in FIGS. 5, 10 is performed simultaneously in one frame.

It is to be noted that in the present embodiment, the same row (fourth row) is selected at different times in the whole region decimation signal and the middle portion continuous signal, and therefore an accumulation time of the row is sometimes different from that of another row. However, in this case, all row accumulation times can be set to be uniform using an electronic shutter.

According to the seventh embodiment described above, a certain degree of resolution can be achieved both in horizontal and vertical directions. Furthermore, in the case of the high pixels, when the pixel signals are output simultaneously, a problem occurs in a frame rate. However, since the reading of the whole region decimation signal (e.g., for display), and the reading of the middle portion continuous signal (e.g., for AF) are simultaneously performed in one frame according to the present embodiment, outputs are easily obtained in accordance with use applications.

### EIGTH EMBODIMENT

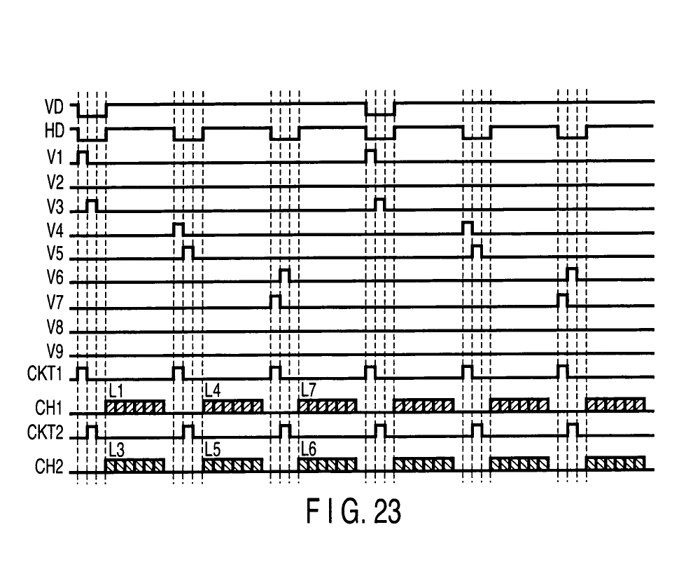

A solid-state image sensing apparatus according to an eighth embodiment of the present invention will be described hereinafter in detail with reference to FIGS. 12, 23. It is to be noted that FIG. 12 shows a reading pattern example of a middle portion continuous signal, and FIG. 23 is a timing chart showing timings for reading the signals shown in FIGS. 5, 12 simultaneously in one frame in detail. FIG. 5 is hereinafter appropriately referred to.

Also in the eighth embodiment, the constitution of FIG. 21 is adopted as a vertical scanning circuit 30.

In the solid-state image sensing apparatus according to the eighth embodiment, the reading of the middle portion continuous signal and the reading of the whole region decimation signal shown in FIG. 12 are simultaneously performed in one frame.

A characteristic reading operation by the solid-state image sensing apparatus according to the eighth embodiment will be described hereinafter in further detail with reference to the timing chart of FIG. 23.

First, prior to operation description, meanings/contents of symbols for use in FIG. 23 are defined.

In FIG. 23, VD means a vertical synchronous signal. HD means a horizontal synchronous signal. CKT1, 2 mean transfer signals for controlling the transfer switches 13-1 to 13-m, 23-1 to 23-m to be on/off. V1 to Vn (here n=9) mean row selection signals output from the vertical scanning circuit 30. Additionally, CH1, CH2 also mean pixel signals output from the respective output channels.

When the operation starts, the vertical scanning circuit 30 first scans the first row along an arrangement direction of units 30-1, 30-2, . . . , 30-n. That is, when the row selection signal V1 output from the vertical scanning circuit 30 turns to an “H” level in a horizontal blanking period (period in which the horizontal synchronous signal HD has an “L” level), pixels P11 to Pm1 of a first row are selected.

In this period, since the clock CKT1 input into transfer switches 13-1 to 13-m have the “H” level, pixel signals of the selected pixels P11 to Pm1 are stored in line memories 12-1 to 12-m. Thereafter, units 10-1, 10-4, 10-7, 10-10, 10-13, 10-16 among the respective units of the horizontal scanning circuit 10 output horizontal selection signals in a horizontal valid period (period in which the horizontal synchronous signal HD has the “H” level), and the pixel signals of the pixels in the selected first, fourth, seventh, tenth, 13-th, 16-th columns in the pixels P11 to Pm1 of the first row are output from an output channel CH1 via horizontal selection switches 11-1, 11-4, 11-7, 11-10, 11-13, 11-16.

Subsequently, the vertical scanning circuit 30 scans the third row along the arrangement direction of the respective units 30-1, 30-2, . . . , 30-n in the same horizontal blanking period. That is, when a row selection signal V3 output from the vertical scanning circuit 30 turns to the “H” level, pixels P13 to Pm3 of the third row are selected. In this period, since the clock CKT2 input into transfer switches 23-1 to 23-m has the “H” level, the pixel signals of the selected pixels P13 to Pm3 are stored in line memories 22-1 to 22-m.

Thereafter, 20-7 to 20-12 among the respective units of the horizontal scanning circuit 20 output horizontal selection signals in a horizontal valid period (period in which the horizontal synchronous signal HD has the “H” level), and the pixel signals of the pixels of the selected seventh to 12-th columns among the pixels P13 to Pm3 of the third row are output from the output channel CH2 via horizontal selection switches 21-7 to 21-12.

The eighth embodiment is characterized in that a timing of the reading of the middle portion continuous signal is shifted from that of the reading of the whole region decimation signal (timing for setting the transfer signals CKT1, CKT2 to the “H” level) in order to prevent the pixel signals of the vertical signal line from being mixed with each other. Thereafter, the fourth and fifth, seventh and sixth rows are similarly selected in the same horizontal blanking period, these pixel signals are simultaneously read from CH1, CH2 in the horizontal valid period, and accordingly the reading shown in FIGS. 5, 12 is performed simultaneously in one frame.

It is to be noted that in the eighth embodiment, the different rows are selected for the whole region decimation signal and the middle portion continuous signal. Therefore, there is no phenomenon in which rows different in an accumulation time are generated as in the seventh embodiment.

According to the eighth embodiment described above, a certain degree of resolution can be achieved both in horizontal and vertical directions. Furthermore, in the case of the high pixels, when the pixel signals are output simultaneously, a problem occurs in a frame rate. However, since the reading of the whole region decimation signal (e.g., for display), and the reading of the middle portion continuous signal (e.g., for AF) are alternately repeated for each frame according to the present embodiment, outputs are easily obtained in accordance with use applications.

The first to eighth embodiments of the present invention have been described above, but the present invention is not limited to these embodiments, and can variously improved and modified within the scope of the present invention. For example, usually performed FPN canceling is performed in an MOS type solid-state image sensing apparatus, or decimation signals of all regions are read in a mixed manner in order to suppress false signals.

In the fifth to eighth embodiments of the present invention, the operations for performing the decimation scanning of the horizontal and vertical scanning circuits have been described. To perform the operations, the use of a decoder circuit or the use of a shift register in a scanning circuit can be realized in a decimation scanning method described, for example, in Jpn. Pat. Appln. KOKAI Publication No. 9-163245, and, needless to say, all the pixels can be successively read by performing the successive scanning.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A solid-state image sensing apparatus comprising:
a photoelectric conversion unit constituted of a plurality of two-dimensionally arranged pixels;
a vertical scanning circuit which selects a pixel row constituting a reading object of the photoelectric conversion unit;
a transfer switch which is connected to an output signal line of each of the pixels and which is driven/controlled by a transfer signal;
a line memory which stores a pixel signal transferred from the pixel via the transfer switch;
a horizontal scanning circuit which outputs a horizontal selection signal;
a horizontal selection switch which is driven/controlled by the horizontal selection signal; and
an output channel which reads the pixel signal from the line memory via the horizontal selection switch,
wherein reading of a middle portion continuous signal of the pixel and reading of a whole region decimation signal of the pixel are alternately performed for each frame in accordance with a use application by control of the vertical scanning circuit and the horizontal scanning circuit.

2. The solid-state image sensing apparatus according to claim 1, wherein the pixel row selected in reading the middle portion continuous signal is common to that selected in reading the whole region decimation signal, and further with regard to each selected pixel row, the pixel signal of a middle portion is read as the middle portion continuous signal, and the pixel signal obtained by decimation every predetermined pixels is read as the whole region decimation signal.

3. The solid-state image sensing apparatus according to claim 1, wherein the pixel signal of the middle portion is read in a vertical direction without decimation in reading the middle portion continuous signal, and further a charge of the read pixel is reset at a predetermined timing to thereby set an accumulation time in the photoelectric conversion unit to be uniform.

4. The solid-state image sensing apparatus according to claim 3, wherein a period of a horizontal synchronous signal relating to the reading of the whole region decimation signal is integer times that of a horizontal synchronous signal relating to the reading of the middle portion continuous signal.

5. The solid-state image sensing apparatus according to claim 1, wherein the pixel row selected in reading the middle portion continuous signal is different from that selected in reading the whole region decimation signal, and further a charge of the read pixel is reset at a predetermined timing to thereby set an accumulation time in the photoelectric conversion unit to be uniform.

6. The solid-state image sensing apparatus according to claim 5, wherein a period of a horizontal synchronous signal relating to the reading of the whole region decimation signal has the same phase as that of a horizontal synchronous signal relating to the reading of the middle portion continuous signal.

7. A solid-state image sensing apparatus comprising:
a photoelectric conversion unit constituted of a plurality of two-dimensionally arranged pixels;
a vertical scanning circuit which selects a pixel row constituting a reading object of the photoelectric conversion unit;
a transfer switch which is connected to an output signal line of each of the pixels and which is driven/controlled by a transfer signal;
a line memory which stores a pixel signal transferred from the pixel via the transfer switch;
a horizontal scanning circuit which outputs a horizontal selection signal;
a horizontal selection switch which is driven/controlled by the horizontal selection signal; and
a plurality of output channels which read the pixel signals via the horizontal selection switch,
wherein reading of a middle portion continuous signal of the pixel and reading of a whole region decimation signal of the pixel are simultaneously performed in one frame by control of the vertical scanning circuit and the horizontal scanning circuit.

8. The solid-state image sensing apparatus according to claim 7, wherein the pixel row selected in reading the middle portion continuous signal is common to that selected in reading the whole region decimation signal, and further with regard to each selected pixel row, the pixel signal of a middle portion is read as the middle portion continuous signal, and the pixel signal obtained by decimation every predetermined pixels is read as the whole region decimation signal.

9. The solid-state image sensing apparatus according to claim 7, wherein the pixel row selected in reading the middle portion continuous signal is different from that selected in reading the whole region decimation signal, and further a timing at which the transfer switch conducts in reading the middle portion continuous signal is shifted from that in reading the whole region decimation signal to thereby prevent the pixel signals from being mixed in the output signal line.

10. A solid-state image sensing apparatus comprising:
a photoelectric conversion unit constituted of a plurality of two-dimensionally arranged pixels;
a vertical scanning circuit which selects a pixel row constituting a reading object of the photoelectric conversion unit;
first and second transfer switches which are connected to one end and the other end of an output signal line of each of the pixels and which are driven/controlled by first and second transfer signals, respectively;
first and second line memories which store pixel signals transferred from the pixels via the first and second transfer switches;
first and second horizontal scanning circuits which output first and second horizontal selection signals, respectively;
first and second horizontal selection switches which are driven/controlled by the first and second horizontal selection signals; and
first and second output channels which read the pixel signals via the first and second horizontal selection switches,
wherein reading of a middle portion continuous signal of the pixel by driving/controlling of the first horizontal selection switch by the first horizontal selection signal and reading of a whole region decimation signal of the pixel by driving/controlling of the second horizontal selection switch by the second horizontal selection signal are simultaneously performed in one frame.

11. The solid-state image sensing apparatus according to claim 10, wherein the pixel row selected in reading the middle portion continuous signal is common to that selected in reading the whole region decimation signal, and further with regard to each selected pixel row, the pixel signal of a middle portion is read as the middle portion continuous signal, and the pixel signal obtained by decimation every predetermined pixels is read as the whole region decimation signal.

12. The solid-state image sensing apparatus according to claim 10, wherein the pixel row selected in reading the middle portion continuous signal is different from that selected in reading the whole region decimation signal, further timings at which the first and second transfer switches conduct are shifted in reading the middle portion continuous signal and in reading the whole region decimation signal to thereby set reading timings to be different from each other, and the pixel signals are prevented from being mixed in the output signal line.
